(19) United States
(12) Patent Application Publication
(10) Pub. No.: US 2005/0056573 A1
(43) Pub. Date: Mar. 17, 2005

(54) Exception mail handling

(75) Inventor: Peter Berdelle-Hilge, Konstanz (DE)

Correspondence Address: SIEMENS SCHWEIZ;I-44, INTELLECTUAL PROPERTY, ALBISRIEDERSTRASSE 245, ZURICH, CH-8047, CH

(73) Assignee: SIEMENS AKTIENGESELLSCHAFT, MUNICH (DE)

(21) Appl. No.: 10/933,355

(22) Filed: Sep. 3, 2004

Related U.S. Application Data
(60) Provisional application No. 60/499,612, filed on Sep. 3, 2003.

(51) Int. Cl. B07C 5/00

(52) U.S. Cl. 209/584; 209/583; 209/900

(57) ABSTRACT

The present invention relates to article handling and sorting and in particular to a system and method for handling and sorting both regular and exception articles. Regular articles are ones which fit into an article bin assigned to the article's destination address. Exception articles are ones which no longer fit due to volume concerns. In operation, a first sort of the article batch is performed into bins or PODs assigned to regular and exception articles. The exception articles are extracted, polywrapped and sorted a second time in sequence of delivery. The exception articles are also sorted in sequence of delivery. Markers are inserted into the regular article stack to indicated where an exception article should have gone. After the second sort, the articles are again extracted, exception articles first. Related regular articles are then extracted and the exception articles are manually inserted where marked. Because the exception articles are in sequence order, they will also be in the order of the markings, making manual insertion sequential and therefore easier. The present invention also includes a system for performing the above.

### CROSS REFERENCE TO RELATED APPLICATIONS

The present application claims priority to provisional patent application 60/499,612, filed on Sep. 3, 2003, which is herein incorporated by reference.

### BACKGROUND OF THE INVENTION

The present invention relates to article handling systems and methods and more particularly to a system and method for article extraction which provides an decrease in cost and an increase throughput efficiency over related prior art systems. As used throughout the application, articles refer to mail items, magazines, books and other such items. It is however within the scope of the present invention that other articles, as would be imagined by one skilled in the art, may be included in the definition of articles. In the sorting of such articles, it is known to use Delivery Point Packaging (DPP) in order to provide such articles sorted and in sequence. Articles are sorted into pockets of limited size. When the number of articles exceeds the storage capacity of a pocket, it becomes necessary to deal with overruns and/or exception articles. Such overruns may be caused by total article volume as well as individual article thickness. Accordingly, it is necessary to deal with overruns without increasing costs, engineering, machine size and so forth.

There are typically three main steps in article sorting: article singulation, article transportation to separate out output bins corresponding to appropriate destination addresses, and article extraction from the output bins to other devices for further handling. Such further handling may include polywrapping, re and/or further sorting, and the like. Various article handling systems are proposed in the art.

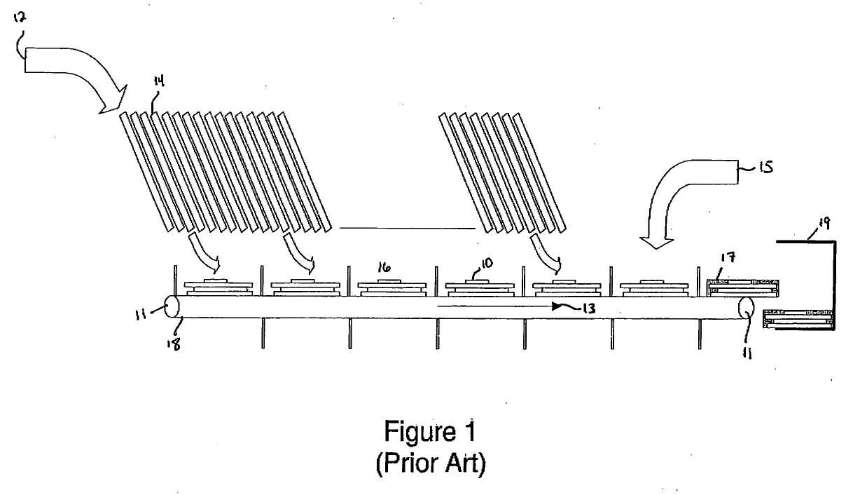

FIG. 1 depicts a pocket sorter system which provides for simple merging with manual and/or DPS articles, the possibility of any kind of packaging at the end, and a simple sorting algorithm. This design's disadvantages include a tremendous number of active and controlled pockets, the necessity for an article sequencing process, and a short time window because of the late arrival time of sequenced articles. In operation, articles 10 arrive from an external feeder and scanner (depicted by arrow 12) into select individual pockets 14. The articles are then sorted into appropriate sections 16 of collection belt 18. Belt 18 is an endless loop about two rotating means 11 facilitating belt movement in the direction indicated by arrow 13. Provision is made for manual sorting 15 of articles on the belt 18 as well. The articles 10 are polywrapped 17 and stacked in a tray 19 for further processing.

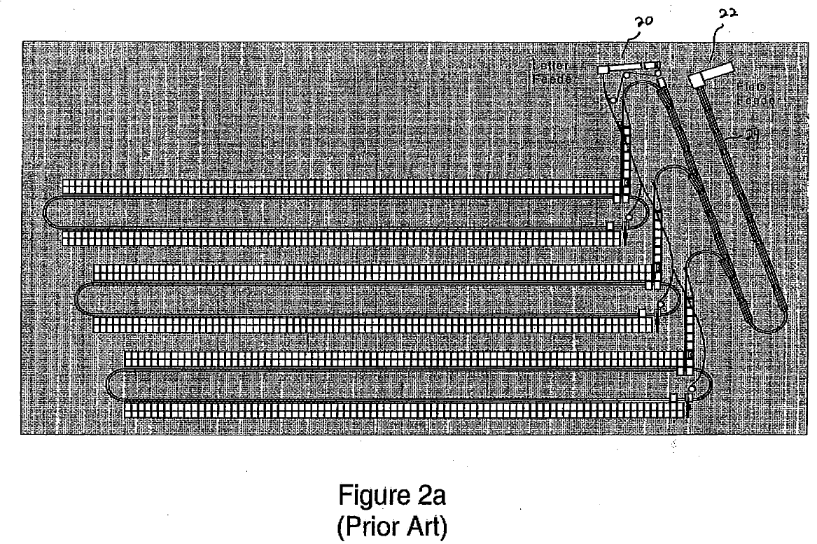

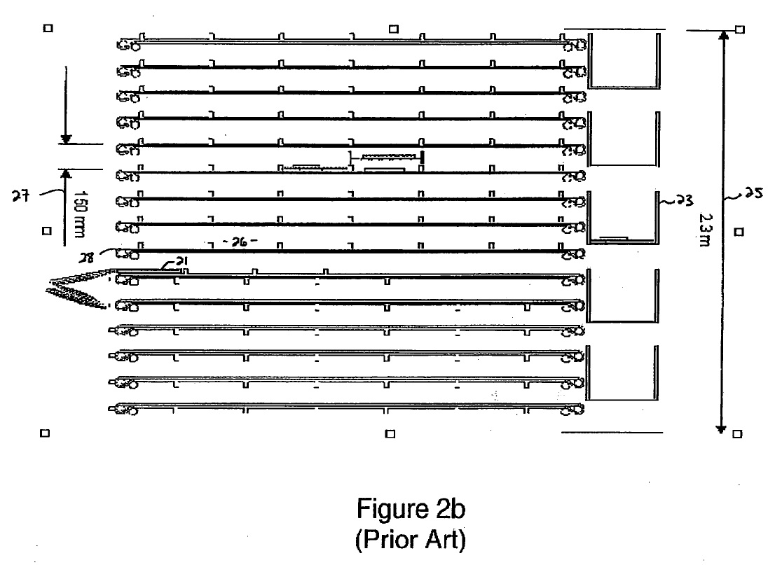

FIGS. 2a and 2b depict a flat bed sorter arrangement which provides lower throughput performance per loading point, simple automatic emptying and packaging with mail compressing, and no need for autonomous vehicle technology because of the flat bed pockets. Disadvantages of the flat bed sorter include one shuttle loading point for each level of casing sections, greater length of shuttle track system in the casing sections, and existing impact of mail mix-grade and volume conditions on throughput. In operation, articles are introduced at respective feeders 20, 22 and transported 24 to endless sectioned (26) belts 28 which receive the articles 21 and stack them intro trays 23. The design has a width (25) of about 2.3 meters and the belts are spaced about 150 mm apart (27).

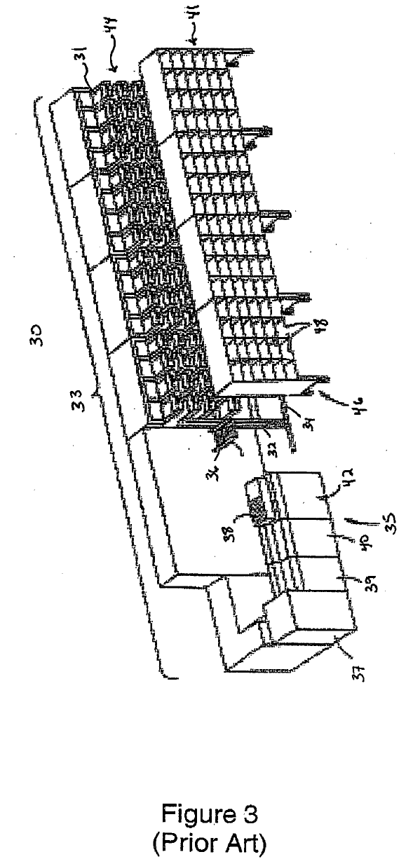

The transporting of cartridges and/or articles is also disclosed in the prior art as exemplified by U.S. Pat. No. 6,135,697. FIG. 3 depicts a transport system 30 comprising a robotic arm 32 travelling along track 34 for effecting delivery of cartridge(s) 36 and/or articles 38 to appropriate compartments 31. The transport system 30 comprises a sorter 33 and autofeeder 35. The autofeeder 35 has several components including a feeding station 37, jogging edging station 39, queuing station 40, and docking station 42. Positioned atop the docketing station is a cartridge 36 filled with articles 38. The robotic arm 32 is used to relocate the cartridge 36 to a select compartment 31 of compartment array 44. The robotic arm 32 travels along a track 34 running parallel to the compartment array 31. As may be required, a buffer shelf 46 is included having a plurality of buffer compartments 48 arranged in an array 41, which the robot arm also serves.

The prior art systems rely upon a same device or combination of devices to both load and extract articles and/or cartridges from their respective storage areas. The device(s) must serve each storage area individually. Such loading and extraction processes are expensive and present engineering challenges. These and other burdens carry over into subsequent processes for article handling, including polywrapping, refeeding and the like.

### SUMMARY OF THE INVENTION

It is an object of the present invention to provide a method of using a DPP machine to sort and sequence exception articles. Another object is to provide a system comprising means for performing the above method. It is a further object to provide and otherwise implement the method without increasing costs, DPP engineering requirements, DPP size, and the like. These and other objects are achieved by the present inventive method wherein exception article PODs are allocated to regular article PODs, the articles are completely sorted a first time with use being made of the exception and regular PODs, the articles are extracted and possibly polywrapped, the articles are then sorted and sequenced according to delivery points to regular and exception PODs, and the finally extracted and manually merged. The present invention is also directed to a system for implementing the aforementioned method.

### DETAILED DESCRIPTION OF THE SEVERAL VIEWS OF THE DRAWINGS

The present invention will be set out in more detail below with reference to the following drawing which depict:

FIGS. 1-3 depict prior art article handling systems;

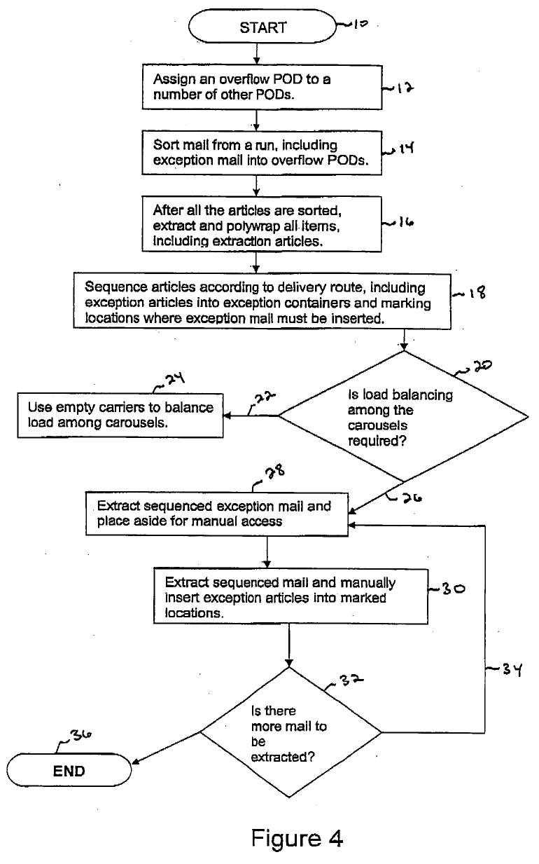

FIG. 4 depicts a flowchart of the present method; and

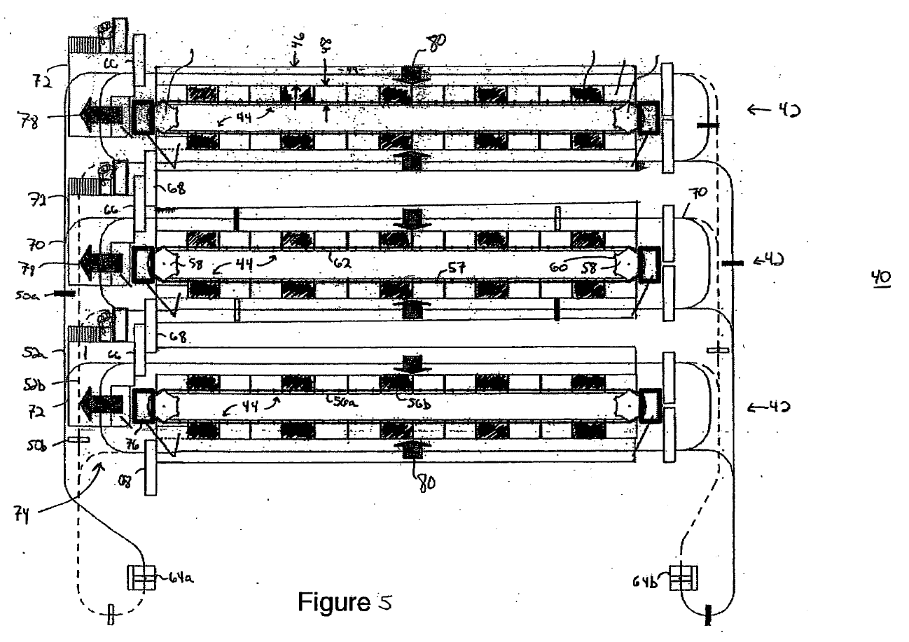

FIG. 5 depicts a schematic overview for implementing the method of FIG. 4.

### DETAILED DESCRIPTION OF THE INVENTION

FIG. 4 depicts a flowchart of the present method. As set out, the method begins (10) and proceeds to step 12 wherein an overflow or exception POD is assigned to one or more regular article PODs. As will be depicted in FIG. 5, the ratio of regular to exception PODs is two to one. However, other ratios may be used as required by application, such as ten to one. The assignment may be performed logically by appropriate control and computer means. PODs comprise a plurality of pockets, each for receiving at least one article. The pockets are logically assigned to at least one destination point. Accordingly, before a sorting run, regular POD pockets may be logically assigned to select destination addresses while the exception POD pockets may be logically and dynamically assigned to the same destination addresses with the understanding that an overflow may not occur for all destination addresses thereby freeing up additional pockets to assist with exceptionally heavy article flow to some destination addresses. The exception PODs may be located proximate to or distant from the regular PODs.

The method proceeds to step 14 wherein a sorting run is performed. The articles are sorted according to destination address to regular pockets and then overflow pockets as the case may require. After the sorting run is completed, the method continues to step 16 wherein the articles are extracted and further processed. Such further processing may include polywrapping—the wrapping of articles in a suitable plastic to protect them for further processing and delivery. Both regular and exception articles are subject to polywrapping. Article polywrapping may be made by means known to one skilled in the art. After the further processing, the exception articles are sorted a second time in sequence of delivery (step 18). Exception articles are sorted into exception PODs positioned proximate to related regular PODs which do not require a second sequence sorting because they are already sequenced. Should it be required to additionally sort regular articles, such regular articles get treated as if they were exception articles. During the sorting of the regular articles, markers and the like are inserted into the regular PODs at locations where the exception articles would be inserted. Marking may also be performed when the articles are extracted and before containerization (sorting into a container or tray). In an another embodiment, same destination articles are assigned a common number to facilitate article handling. Next, a determination is made whether a load balancing is required among the various carousels assigned to various delivery routes (step 20). Load balancing may be a factor when different delivery routes comprise substantially different article delivery loads. As such, some carousels may require more storage room than others to handle the heavy load, such other room may be made up by other carousels currently experiencing a lighter load. If load balancing is required (step 22), then carriers from a same or other carousels are employed (step 24), the carriers being just emptied during extraction and therefore available for additional articles thanks to an indexing of the carousel which brings the just emptied carriers into a loading zone. Of course in a first pass, carriers in an extraction zone do not get filled and accordingly are available as well upon an indexing for loading balancing. Alternatively, other PODs or pockets may be used.

If load balancing is not required (step 26), then the second sort is completed and the articles, by delivery route are extracted, the articles now being in delivery route sequence (step 28). During the extraction, the exception articles are extracted first and placed aside and within range of a manual operator. Then the regular articles are extracted and the exception articles inserted (step 30) in their respective marked locations. The exception and regular articles will be in sequence, accordingly, the manual insertion process proceeds in sequentially. A determination is made as to whether more articles needs to be extracted (step 32). If more articles are to be extracted, the method returns (step 34) to step 28 described above. If no more articles require extraction, then the method ends 37 (step 36) to step 10, start, described above.

FIG. 5 depicts a DPP system for implementing the method described above with respect to FIG. 1. The system is depicted from the top down FIG. 5 depicts a carousel system 40 comprising three carousels 42. The number of carousels is a matter of design choice. The carousels comprise segmented towers 44 arranged in a closed loop. As depicted, the loop is oval shaped by design choice. The towers comprise a number of vertically displaced levels. By way of example, the number of layers may be six. Because FIG. 5 depicts a view from above, only the top level is shown. However, the levels are substantially identical in function and design. Accordingly, the system will be described with respect to its top layer with the understanding that the same or similar components apply to the other levels.

The towers comprise two adjacent sections, a static vehicle frame 46 and a carrier displacement section 48. The static vehicle frame 46 defines a vehicle passage 49 in which vehicles travel. The vehicles may be autonomous article carriers (ANTs) depicted as rectangles travelling on a track. The ANTs comprise means for receiving articles, means for navigating the passages to an appropriate pocket, and means for delivering articles into pockets. ANTs accommodating articles therein are depicted filled in 50a while empty ANTs are depicted outline 50b. The track portions leading to the pockets are depicted as solid lines 52a and the track portions leading away from the pockets are depicted as dashed lines 52b. The vehicle passage may include a track or monorail for guiding the ANT. The track may be on the floor or ceiling of the passage. The passage is open in the direction of the carrier displacement section 48 and laterally along the passage path. The system includes one passage per level.

The carrier displacement section 48 comprises a plurality of laterally displaceable carriers 50, each comprising a number of vertically displaced PODs, and pockets therein (not shown). Given the top view of FIG. 5, only the top level carriers are depicted. PODs assigned to regular articles are depicted in outline 56a and PODs assigned to exception articles are bolded 56b. The carriers may travel on a track and/or wheels. The track my be located above or below the carrier so as to provide appropriate vertical support. The carrier in turn comprises appropriate travel means 57 to facilitate lateral travel as guided by the track or wheels. Horizontal support for the carriers or lateral guidance may be provided by an interface with the provided appropriate support therefrom. Lateral guidance may be provided by an interface between the carrier and the static vehicle frame. The vehicle passage and PODs are coplanar and spaced apart a sufficient distance so as to facilitate ANT deposition of articles into pockets.

Two coq wheels 58 are positioned at opposite ends of the carousel closed loop. The wheels include extensions 60 which interface with the carrier travel means so as to provide sufficient lateral force to displace the carriers. The carriers are connected to one another by means of a bridge 62 connecting adjacent carrier travel means 57.

The system includes a pair of loading points 64a and 64b. To facilitate vertical elevation of ANTs, the system include appropriately placed divert elevators 66. Vertical descent of the ANTs is achieved by appropriately placed merge elevators 68. Horizontal displacement of the ANTs is effected by appropriately placed switches 70. An extraction zone 72 is located at one end 74 of the carousel and PODs being extracted are depicted in bold 76. The extraction direction is indicated by arrows 78 and the loading direction is indicated by arrows 80.

For oversized articles, at least one special container 82 is assigned. Container 82 may be located outside the casing towers 42. In a first sort, the oversized articles are deposited into the special container(s). In a second sort, the oversized articles are sorted into the carousels into appropriate specially sized pockets in delivery order sequence. Depending upon application, it may or may not be desirable to polywrap the exception articles.

In an alternate embodiment, all of the exception PODs may be located on one level with the remaining regular and any exception PODs being dispersed about the other levels. Likewise, more than one extraction zone may be included per carousel.

The invention being thus described, it will be obvious that the same may be varied in many ways. Such variations are not to be regarded as a departure from the spirit and scope of the invention, and all such modifications would be obvious to one skilled in the art are intended to be included within the scope of the following claims.

1. A method for handling articles, comprising:
assigning a first number of regular PODs to regular sorted articles and a second number of exception PODs to exception articles;
effecting a first sort of a batch of articles such that regular articles are sorted into said regular PODs and exception articles are sorted into said exception PODs;
extracting said batch of articles;
effecting a second sort of said batch of articles, said second sort being in delivery order sequence with exception articles sorted into said exception PODs;
inserting a marking within a sequence of regular articles to indicate an insertion place for an exception article;
extracting said exception articles;
extracting said regular articles;
and manually inserting exception articles into respective insertion places.

2. The method according to claim 1, wherein said step of extracting said batch of articles further comprises the step of polywrapping extracted articles.

3. The method according to claim 1, wherein said exception PODs are located upstream in a direction of a loading zone from said regular PODs.

4. The method according to claim 1, wherein said step of assigning further comprises the step of assigning exception PODs to regular PODs based upon at least one common destination address.

5. The method according to claim 4, wherein said exception PODs are located upstream from said regular PODs.

6. The method according to claim 5, wherein a ratio of said first number to said second number is ten to one.

7. The method according to claim 1, wherein the step of assigning further comprises the step of logically assigning at least one pocket to a destination address.

8. The method according to claim 7, wherein said at least one pocket is located within an exception POD.

9. The method according to claim 1, wherein exception articles extracted in said step of extracting said exception articles is in delivery order sequence.

10. The method according to claim 9, wherein said exception articles are in marking order.

11. The method according to claim 1, wherein said first and second sort are made into a plurality of carousels.

12. The method according to claim 11, wherein said step of effecting a second sort further comprises the step of determining if load balancing among the carousels is required.

13. The method according to claim 12, further comprising the step of using a just emptied POD for load balancing if load balancing is required.

14. The method according to claim 1, wherein said articles comprise at least one of mail items, magazines, books and other such flat items.

15. The method according to claim 1, further comprising the step of indexing the carousel after a first sort.

16. The method according to claim 1, further comprising the steps of:
assigning at least one oversized article container to an oversized article;
in a first sort, sorting oversized articles into said oversized article container; and
in a second sort, sorting said oversized articles into exception PODs in sequence.

17. The method according to claim 16, further comprising the step of diverting said oversized article POD

18. A system for handling articles comprising:
means for assigning a first number of regular PODs to regular sorted articles and a second number of exception PODs to exception articles;
means for effecting a first sort of a batch of articles such that regular articles are sorted into said regular PODs and exception articles are sorted into said exception PODs;
means for extracting said batch of articles;
means for effecting a second sort of said batch of articles, said second sort being in delivery order sequence with regular articles sorted into said regular PODs and exception articles sorted into said exception PODs;
means for inserting a marking within a sequence of regular articles to indicated an insertion place for an exception article;
means for extracting said exception articles; and
means for extracting said regular articles;
and manually inserting exception articles into respective insertion places.

19. The system according to claim 15, further comprising at least one extraction module.

20. The system according to claim 16, wherein said extraction module comprises POD extraction means.

21. The system according to claim 16 wherein said extraction station comprises article polywrapping means.

22. The system according to claim 15, wherein said regular PODs and extraction PODs are located in a carousel system, said carousel system comprising at least one segmented tower having a plurality of vertically displaced levels.

23. The system according to claim 19, wherein each of said levels comprises at least one regular and one extraction POD.

24. The system according to according to claim 19, wherein one of said levels comprises only exception PODs.

25. The system according to claim 15, wherein said exception PODs are located upstream in a direction of a loading zone from said regular PODs.

26. The system according to claim 15, wherein said means for assigning further comprises means for assigning exception PODs to regular PODs based upon at least one common destination address.

27. The system according to claim 22, wherein said exception PODs are located upstream from said regular PODs.

28. The system according to claim 15, wherein a ratio of said first number to said second number is two to one.

29. The system according to claim 15, further comprising means for indexing the carousel after a first sort.

30. The system according to claim 15, wherein said means for assigning further comprises means for logically assigning at least one pocket to a destination address.

31. The system according to claim 26, wherein said at least one pocket is located within an exception POD.

32. The system according to claim 15, wherein exception articles extracted by said means for extracting said exception articles are in delivery order sequence.

33. The system according to claim 28, wherein said exception articles are in marking order.

34. The system according to claim 15, wherein said first and second sort are made into a plurality of carousels.

35. The system according to claim 30, wherein said means for effecting a second sort further comprises means for determining if load balancing among the carousels is required.

36. The system according to claim 31, further comprising means for using a just emptied POD for load balancing if load balancing is required.

37. The system according to claim 15, wherein said articles comprise at least one of mail items, magazines, books and other such flat items.
